(19) United States
(12) Patent Application Publication
(10) Pub. No.: US 2007/0258717 A1
(43) Pub. Date: Nov. 8, 2007

(54) Optical device and wavelength conversion method and optical fiber suitable for them

(76) Inventors: Masaaki Hirano, Kanagawa (JP); Tetsuya Nakanishi, Kanagawa (JP); Toshiaki Okuno, Kanagawa (JP); Masato Tanaka, Kanagawa (JP)

Correspondence Address: MCDERMOTT WILL & EMERY LLP, 600 13TH STREET, N.W., WASHINGTON, DC, 20005-3096, US

(21) Appl. No.: 11/797,212

(22) Filed: May 1, 2007

(30) Foreign Application Priority Data
May 1, 2006 (JP) 2006-127684

(51) Int. Cl. H04J 14/02

(52) U.S. Cl. 398/92

(57) ABSTRACT

An optical device and wavelength conversion method can selectively perform wavelength conversion of a probe lightwave. An optical fiber is suitable for them. The device 1 comprises (a) a pump light source 12 for outputting a pump lightwave having a wavelength of λₚᵤₘₚ and (b) an optical fiber 11 that guides the pump lightwave and a probe lightwave having a wavelength of λ_{probe} and generates through a nonlinear optical phenomenon an idler lightwave having a newly produced wavelength of λ_{idler} that is in accordance with the wavelength λ_{probe}. The wavelength λ_{probe} dependence of the efficiency of the wavelength conversion has a main band including the wavelength λₚᵤₘₚ and a subband distinct from the main band. The probe lightwave included in the subband is guided in the optical fiber 11 to generate in it the idler lightwave having the wavelength λ_{idler} that is in accordance with the wavelength λ_{probe}.

### BACKGROUND OF THE INVENTION

1. Field of the Invention

The present invention relates to an optical device in which a pump lightwave and a probe lightwave are guided in an optical fiber so that a nonlinear optical phenomenon is generated in the optical fiber and an idler lightwave whose wavelength is in accordance with the wavelength of the probe lightwave is newly produced. The present invention also relates to the above described wavelength conversion method. The present invention further relates to an optical fiber suitable for the foregoing optical device and wavelength conversion method.

2. Description of the Background Art

When a high power pump lightwave having a wavelength of λₚᵤₘₚ and a probe lightwave having a wavelength of λ_{probe} are guided in an optical fiber having a highly nonlinearity, a four-wave mixing, which is one type of the nonlinear optical phenomena, is generated in the optical fiber. As a result, an idler lightwave having a newly produced wavelength of λ_{idler} that is in accordance with the wavelength λ_{probe} is generated in the optical fiber. Thus, the wavelength conversion can be performed from λ_{probe} to λ_{idler}. Such a wavelength conversion technique and a highly nonlinear optical fiber suitable for the wavelength conversion have been disclosed in the Internationally published pamphlet 99/10770 and the Japanese patent application laid open No. 2002-207136, for example.

The application of the wavelength conversion technique is not limited to the wavelength conversion of the signal lightwave in an optical communication system. The introduction of a control pulse lightwave into an optical fiber as a pump lightwave can produce an optical switch, a demultiplexer, an optical sampling monitor, and so on. In addition, a photon can be generated that has the same information as that of the original lightwave and that has a newly produced wavelength. Consequently, a photon pair for quantum cryptographic communication can also be produced. Furthermore, a lightwave having a wavelength that has no proper light source can also be easily produced.

Generally, in the wavelength conversion technique using the four-wave mixing generated in a dispersion-shifted optical fiber, a wavelength band of the wavelength-convertible probe lightwave (wavelength conversion band) is continuous over at least 10 nm including the wavelength of the pump lightwave. So far, attention has been paid to the broadening of the wavelength conversion band. However, in the wavelength division multiplexing (WDM) optical communication system, it has been difficult to convert the wavelength only for a signal lightwave having a specific wavelength included in the WDM signal lightwaves. It has also been difficult to change the wavelength conversion band.

### SUMMARY OF THE INVENTION

An object of the present invention is to offer an optical device that can selectively perform wavelength conversion of a probe lightwave. Another object of the present invention is to offer the above-described wavelength conversion method. Yet another object is to offer an optical fiber suitable for the foregoing optical device and wavelength conversion method.

To attain the foregoing object, the present invention offers an optical device that is provided with the following components: (a) a pump light source for outputting a pump lightwave having a wavelength of λₚᵤₘₚ, (b) a multiplexer for combining the pump lightwave and a probe lightwave having a wavelength of λ_{probe}, and (c) an optical fiber that: (c1) guides the pump lightwave and the probe lightwave, and (c2) generates through a nonlinear optical phenomenon an idler lightwave having a newly produced wavelength of λ_{idler} that is in accordance with the wavelength λ_{probe}. In the optical device, the wavelength λ_{probe} dependence of the efficiency of the wavelength conversion from the probe lightwave to the idler lightwave has a main band including the wavelength λₚᵤₘₚ and a subband distinct from the main band.

The present invention also offers a wavelength conversion method that is provided with the following steps: (a) guiding a pump lightwave having a wavelength of λₚᵤₘₚ and a probe lightwave having a wavelength of λ_{probe} in an optical fiber, and (b) generating an idler lightwave having a newly produced wavelength of λ_{idler} that is in accordance with the wavelength λ_{probe} in the optical fiber through a nonlinear optical phenomenon. In this method: (c) the wavelength λ_{probe} dependence of the efficiency of the wavelength conversion from the probe lightwave having the wavelength λ_{probe} to the idler lightwave having the wavelength λ_{idler} has a main band including the wavelength λₚᵤₘₚ and a subband separated from the main band, (d) at least one probe lightwave included in the subband is guided in the optical fiber, and (e) at least one idler lightwave in accordance with the at least one probe lightwave is generated in the optical fiber.

Here, the efficiency of the wavelength conversion, η, is defined by

$$\frac{{P}_{idler}}{{P}_{probe}} ,$$

where P_{idler} is the intensity of the idler lightwave outputted from the optical fiber, and P_{probe} is the intensity of the probe lightwave inputted into the optical fiber. The main band is a continuous band including the wavelength λₚᵤₘₚ of the pump lightwave. In addition, the main band is such a band that when the maximum value of the efficiency of the wavelength conversion in the band is denoted as η₂, the efficiency of the wavelength conversion throughout the band is at least η₂−3 dB. The subband is such a continuous band that when the maximum value of the efficiency of the wavelength conversion in the band is denoted as η₁, the efficiency of the wavelength conversion throughout the band is at least η₁−3 dB. The main band and the subband are distinct from each other without overlapping each other. Between the main band and the subband, there exist wavelengths whose efficiency of the wavelength conversion is less than η₁−3 dB.

The present invention also offers an optical fiber that has the following properties: (a) the effective area is at most 15 μm² at a wavelength of 1550 nm, (b) the zero-dispersion wavelength lies in a range of 1440 to 1640 nm, (c) the dispersion slope is at least 0.04 ps/nm²/km at the zero-dispersion wavelength, (d) the absolute value in the value of the fourth-order differentiation, β₄, of the propagation constant, β, by the angular frequency, ω, is at least 1×10⁻⁵⁵ s⁴/m at the zero-dispersion wavelength, and (e) the amount of longitudinal variation in the zero-dispersion wavelength is at most ±0.3 nm.

### BRIEF DESCRIPTION OF THE DRAWING

FIG. 1 is a schematic diagram showing a first embodiment of an optical device of the present invention.

FIG. 2 is a schematic diagram showing a second embodiment of an optical device of the present invention.

FIG. 3 is a schematic diagram showing a third embodiment of an optical device of the present invention.

FIG. 4 is a graph showing a relationship between the wavelength of the probe lightwave and the efficiency of the wavelength conversion in an embodiment of an optical device and wavelength conversion method of the present invention.

FIG. 5 is a graph showing the result of a simulation to obtain the relationship between the wavelength of the probe lightwave and the efficiency of the wavelength conversion in an optical fiber that is negative in the value of the fourth-order differentiation, β₄, in the vicinity of the zero-dispersion wavelength.

FIG. 6 is a graph showing the result of an experiment to obtain the relationship between the wavelength of the probe lightwave and the efficiency of the wavelength conversion when the pumping wavelength is 1527.4 nm in the same fiber as used for FIG. 5.

FIG. 7 is a graph showing the result of an experiment to obtain the relationship between the wavelength of the probe lightwave and the efficiency of the wavelength conversion when the pumping wavelength is 1528.3 nm in the same fiber as used for FIG. 5.

FIG. 8 is a graph showing the result of an experiment to obtain the relationship between the wavelength of the probe lightwave and the efficiency of the wavelength conversion when the pumping wavelength is 1529.2 nm in the same fiber as used for FIG. 5.

FIG. 9 is a graph showing the result of a simulation to obtain the relationship between the wavelength of the probe lightwave and the efficiency of the wavelength conversion in an optical fiber that is positive in the value of the fourth-order differentiation, β₄, in the vicinity of the zero-dispersion wavelength.

FIG. 10 is a graph showing the result of an experiment to obtain the relationship between the wavelength of the probe lightwave and the efficiency of the wavelength conversion by using the wavelength of the pump lightwave as a parameter in the same fiber as used for FIG. 5.

FIG. 11 is a graph showing the result of a simulation to obtain the relationship between the wavelength of the probe lightwave and the efficiency of the wavelength conversion in another optical fiber.

FIG. 12 is a graph showing the result of a simulation to obtain the relationship between the wavelength of the probe lightwave and the efficiency of the wavelength conversion in an optical fiber having a relatively small absolute value in the value of the fourth-order differentiation, β₄, in the vicinity of the zero-dispersion wavelength.

FIG. 13 is a graph showing the result of a simulation to obtain the relationship between the wavelength of the probe lightwave and the efficiency of the wavelength conversion in an optical fiber having a larger absolute value than that of the optical fiber used for FIG. 12 in the value of the fourth-order differentiation, β₄, in the vicinity of the zero-dispersion wavelength.

FIG. 14 is a graph showing the result of a simulation to obtain the relationship between the wavelength of the probe lightwave and the efficiency of the wavelength conversion in an optical fiber having a yet larger absolute value in the value of the fourth-order differentiation, β₄, in the vicinity of the zero-dispersion wavelength.

FIG. 15 is a graph showing the result of an experiment to obtain the dependence of the efficiency of the wavelength conversion on the wavelength of the probe lightwave.

FIG. 16 is a graph showing the relationship between the amount of longitudinal variation in the zero-dispersion wavelength and the dispersion slope.

FIGS. 17A to 17F are schematic diagrams showing desirable examples of refractive-index profiles in embodiments of an optical fiber of the present invention.

FIG. 18 is a graph showing the result of an experiment to obtain the dependence of the normalized efficiency of the wavelength conversion on the amount of difference between the wavelengths of the pump lightwave and probe lightwave by using β₄ as a parameter.

FIG. 19 is a graph showing the result of an experiment to obtain the dependence of the normalized efficiency of the wavelength conversion on the wavelength of the probe lightwave by using the wavelength of the pump lightwave as a parameter.

### DETAILED DESCRIPTION OF THE INVENTION

These and other features, aspects, and advantages of the present invention will be better understood through the following description, the appended claims, and the accompanying drawing. In the drawing, the same sign is given to the same element to avoid duplicated explanations.

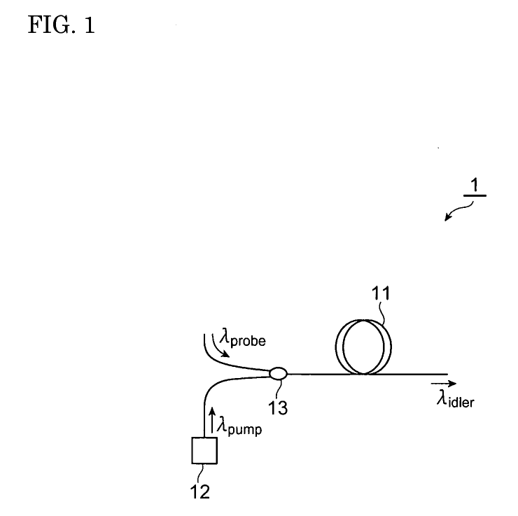

FIG. 1 is a schematic diagram showing a first embodiment of an optical device of the present invention. The optical device 1 is provided with an optical fiber 11, a pump light source 12, and an optical coupler 13. In the optical device 1, a high-power pump lightwave having a wavelength of λₚᵤₘₚ outputted from the pump light source 12 and a probe lightwave having a wavelength of λ_{probe} are combined with the optical coupler 13 to be guided in the optical fiber 11 having a highly nonlinearity. Subsequently, a nonlinear optical phenomenon is generated in the optical fiber 11 and an idler lightwave whose wavelength of λ_{idler} is in accordance with the wavelength λ_{probe} is newly produced, and the idler lightwave is outputted from the optical fiber 11.

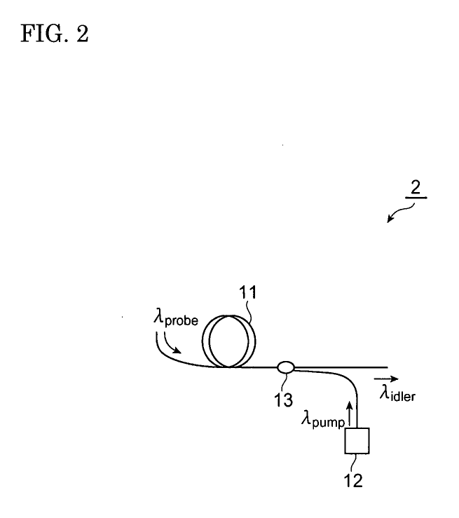

FIG. 2 is a schematic diagram showing a second embodiment of an optical device of the present invention. The optical device 2 is provided with an optical fiber 11, a pump light source 12, and an optical coupler 13. In the optical device 2, a probe lightwave having a wavelength of λ_{probe} is introduced into the optical fiber 11 from one end of it. A high-power pump lightwave having a wavelength of λₚᵤₘₚ outputted from the pump light source 12 is introduced into the optical fiber 11 from the other end of it through the optical coupler 13. The probe lightwave and the pump lightwave are guided in the optical fiber 11 having a highly nonlinearity. Subsequently, a nonlinear optical phenomenon is generated in the optical fiber 11 and an idler lightwave whose wavelength of λ_{idler} is in accordance with the wavelength λ_{probe} is newly produced. The idler lightwave is outputted through the optical coupler 13.

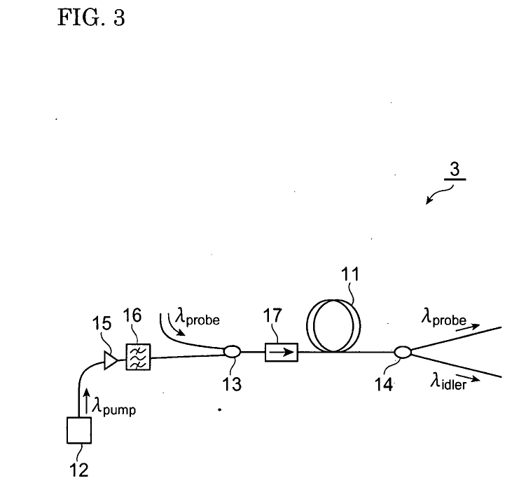

FIG. 3 is a schematic diagram showing a third embodiment of an optical device of the present invention. The optical device 3 is provided with an optical fiber 11, a pump light source 12, an optical coupler 13, an optical coupler 14, an optical amplifier 15, an optical filter 16, and an optical isolator 17. In the optical device 3, a probe lightwave having a wavelength of λ_{probe} is introduced into the optical fiber 11 through the optical coupler 13 and the optical isolator 17. A high-power pump lightwave having a wavelength of λₚᵤₘₚ outputted from the pump light source 12 is introduced into the optical fiber 11 through the optical amplifier 15, the optical filter 16, the optical coupler 13, and the optical isolator 17. A nonlinear optical phenomenon is generated in the optical fiber 11 and an idler lightwave whose wavelength of λ_{idler} is in accordance with the wavelength λ_{probe} is newly produced. The idler lightwave is outputted through the optical coupler 14. The probe lightwave outputted from the optical fiber 11 is also outputted through the optical coupler 14.

In a degenerative four-wave mixing generated in the optical fiber included in the optical devices 1 to 3 (the degenerative four-wave mixing is one type of the nonlinear optical phenomena), the wavelength λₚᵤₘₚ of the pump lightwave, the wavelength λ_{probe} of the probe lightwave, and the wavelength λ_{idler} of the idler lightwave have a mutual relationship shown in Eq. (1).

$$\frac{1}{{λ}_{idler}} = \frac{2}{{λ}_{pump}} - \frac{1}{{λ}_{probe}} . \qquad ( 1 )$$

In this case, as the phase-unmatching parameter, Δβ, defined by Eq. (2) approaches the value zero, the efficiency of the wavelength conversion, η, increases.
Δβ=2βₚᵤₘₚ−β_{probe}−β_{idler} (2),
where βₚᵤₘₚ, β_{probe}, and β_{idler} are the propagation constants of the pump lightwave, probe lightwave, and idler lightwave, respectively, in the optical fiber.

When the phase-unmatching parameter, AB, is Taylor-expanded considering up to the quadratic term, Eq. (3) is obtained.

$$\begin{matrix}Δ β = - {β}_{2} \times 4 {π}^{2} {{c}^{2} ( \frac{1}{{λ}_{pump}} - \frac{1}{{λ}_{probe}} )}^{2} - \\ {β}_{4} \times \frac{4}{3} {π}^{4} {{c}^{4} ( \frac{1}{{λ}_{pump}} - \frac{1}{{λ}_{probe}} )}^{4} \\ = \{ - {β}_{2} - {β}_{4} \times \frac{1}{3} {π}^{2} {{c}^{2} ( \frac{1}{{λ}_{pump}} - \frac{1}{{λ}_{probe}} )}^{2} \} \times \\ 4 {π}^{2} {{c}^{2} ( \frac{1}{{λ}_{pump}} - \frac{1}{{λ}_{probe}} )}^{2} ,\end{matrix} \qquad ( 3 )$$

where β₂: the value of the second-order differentiation of the propagation constant, β, of the optical fiber by the angular frequency, ω, at the wavelength λₚᵤₘₚ, β₄: the value of the fourth-order differentiation of the propagation constant, β, of the optical fiber by the angular frequency, ω, at the wavelength λₚᵤₘₚ, c: the velocity of light in a vacuum, and II: the ratio of the circumference of a circle to its diameter. The phase-unmatching parameter, Δβ, becomes the value zero when Eq. (4) holds except in the case where the wavelength λₚᵤₘₚ is equal to the wavelength λ_{probe}.

$$- {β}_{2} - {β}_{4} \times \frac{1}{3} {π}^{2} {{c}^{2} ( \frac{1}{{λ}_{pump}} - \frac{1}{{λ}_{probe}} )}^{2} = 0. \qquad ( 4 )$$

In an optical fiber in which the value of the fourth-order differentiation, β₄, is nonzero, Eq. (4) holds only when either of the following two cases is satisfied:
case 1: both β₂≈0 and λₚᵤₘₚ≈λ_{probe} are satisfied, and
case 2: Eq. (5) is satisfied.

$$- {β}_{2} = {β}_{4} \times \frac{1}{3} {π}^{2} {{c}^{2} ( \frac{1}{{λ}_{pump}} - \frac{1}{{λ}_{probe}} )}^{2} . \qquad ( 5 )$$

Generally, case 1 is a condition that is satisfied when a dispersion-shifted fiber is used. On the other hand, case 2 is a condition that has not been considered so far. Case 2 can be satisfied only when 1/λₚᵤₘₚ−1/λ_{probe} has a large value to a certain extent and lies in a narrow range. When the above-described condition is satisfied, the four-wave mixing in a narrow band can be achieved.

Case 2 is explained below. Based on Eq. (5), the wavelength conversion is achieved at the wavelength λ_{probe} of the probe lightwave that satisfies Eq. (6).

$$\frac{1}{{λ}_{probe}} = \frac{1}{{λ}_{pump}} \pm \frac{1}{π c} \times {( \frac{- 3 {β}_{2}}{{β}_{4}} )}^{0.5} . \qquad ( 6 )$$

In this case, when the value of β₂/β₄ is shifted, the wavelength-convertible λ_{probe} is also sifted. For example, when it is intended to wavelength-convert a probe lightwave having a wavelength of λ_{probe} =1610 nm, which is in the L-band wavelength range, to an idler lightwave having a wavelength of λ_{idler} =1460 nm by using a pump lightwave having a wavelength of λₚᵤₘₚ =1530 nm, which is in the C-band wavelength range, the following relationship is only required:

$$\frac{{β}_{2}}{{β}_{4}} = - 3 \times {10}^{26} {s}^{- 2} .$$

When the wavelength λₚᵤₘₚ of the pump lightwave is tuned in the vicinity of the zero-dispersion wavelength of the optical fiber, β₂ can be shifted largely while β₄ is shifted little. Therefore, even when the wavelength of the probe lightwave is shifted, the wavelength conversion can be achieved by varying the wavelength λₚᵤₘₚ of the pump lightwave.

When the optical fiber has a small transmission loss, the coefficient of the wavelength conversion, η, is expressed as

$$η = {\{ \frac{sin ( \frac{Δ β L}{2} )}{\frac{Δ β L}{2}} \}}^{2} , \qquad ( 7 )$$

where L: the length of the fiber. The maximum value of ηis 1. The range of λ_{probe} in which η takes a value of 1 to 0.5 becomes the wavelength conversion band defined in the present invention. This range corresponds to the range of ΔβL expressed as
−2.8 <ΔβL<2.8 (8).

Consequently, the absolute value of the difference λ_{probe}_{_{—}}_{A}-λ_{probe}_{_{—}}_{B} is a bandwidth of the wavelength conversion band, in which λ_{probe}_{_{—}}_{A} satisfies Eq. (9) and λ_{probe}_{_{—}}_{B} satisfies Eq. (10).

$$\begin{matrix}\begin{matrix}\frac{- 2.8}{L} = - {β}_{2} \times 4 {π}^{2} {{c}^{2} ( \frac{1}{{λ}_{pump}} - \frac{1}{{λ}_{probe\_A}} )}^{2} - \\ {β}_{4} \times \frac{4}{3} {π}^{4} {{c}^{4} ( \frac{1}{{λ}_{pump}} - \frac{1}{{λ}_{probe\_A}} )}^{4} .\end{matrix} & ( 9 ) \\ \begin{matrix}\frac{2.8}{L} = - {β}_{2} \times 4 {π}^{2} {{c}^{2} ( \frac{1}{{λ}_{pump}} - \frac{1}{{λ}_{probe\_B}} )}^{2} - \\ {β}_{4} \times \frac{4}{3} {π}^{4} {{c}^{4} ( \frac{1}{{λ}_{pump}} - \frac{1}{{λ}_{probe\_B}} )}^{4} .\end{matrix} & ( 10 )\end{matrix}$$

When the difference between Eqs. (9) and (10) is calculated, Eq. (11) is obtained.

$$\begin{matrix}\frac{5.6}{L} = - {β}_{2} \times 4 {π}^{2} {c}^{2} ( \frac{1}{{λ}_{probe\_A}} - \frac{1}{{λ}_{probe\_B}} ) \times \\ ( \frac{2}{{λ}_{pump}} - \frac{1}{{λ}_{probe\_A}} - \frac{1}{{λ}_{probe\_B}} ) - \\ {β}_{4} \times \frac{4}{3} {π}^{4} {c}^{4} ( \frac{1}{{λ}_{probe\_A}} - \frac{1}{{λ}_{probe\_B}} ) \times \\ ( \frac{2}{{λ}_{pump}} - \frac{1}{{λ}_{probe\_A}} - \frac{1}{{λ}_{probe\_B}} ) \times \\ \{ {( \frac{1}{{λ}_{pump}} - \frac{1}{{λ}_{probe\_A}} )}^{2} + {( \frac{1}{{λ}_{pump}} - \frac{1}{{λ}_{probe\_B}} )}^{2} \} .\end{matrix} \qquad ( 11 )$$

Here, it is supposed that the following relationship is established:

$$\frac{1}{{λ}_{pump}} - \frac{1}{{λ}_{probe\_A}} = \frac{1}{{λ}_{pump}} - \frac{1}{{λ}_{probe\_B}}$$

Furthermore, Eq. (6) is substituted into Eq. (11). Then, Eq. (12) is obtained.

$${λ}_{probe\_A} - {λ}_{probe\_B} ≅ \frac{0.7}{π cL} ⨯ {λ}_{probe}^{2} ⨯ {( \frac{- {β}_{4}}{3 {β}_{2}} )}^{0.5} . \qquad ( 12 )$$

Consequently, for example, in the case where a probe lightwave having a wavelength of λ_{probe}=1610 nm is converted to an idler lightwave having a wavelength of λ_{idler}=1460 nm by using a pump lightwave having a wavelength of λₚᵤₘₚ=1530 nm (this case corresponds to the case where

$$\frac{{β}_{2}}{{β}_{4}} = - 3 ⨯ {10}^{26} {s}^{\cdot 2}$$

is established), when it is supposed that L=100 m and β₂=6×10⁻²⁹ s²/m, the conversion bandwidth λ_{probe}_{_{—}}_{A}−λ_{probe}_{_{—}}_{B} becomes nearly 8 nm. Thus, the wavelength conversion in a narrow bandwidth can be achieved.

In addition, because 1/λₚᵤₘₚ−1/λ_{probe} has a large value to a certain extent, when wavelengths of WDM signals are simultaneously converted through the four-wave mixing in a highly nonlinear fiber, the four-wave mixing between the signal lightwaves has little efficiency to be generated, thereby enabling the suppression of the generation of noise. On the other hand, in the conventional method in which the simultaneous wavelength conversion is performed in the main band, the four-wave mixing between the WDM signals causes a noise to the signal.

In an optical device and wavelength conversion method of the present invention, the wavelength λ_{probe} dependence of the efficiency of the wavelength conversion from the probe lightwave having the wavelength λ_{probe} to the idler lightwave having the wavelength λ_{idler} has a main band including the wavelength λₚᵤₘₚ of the pump lightwave and a subband distinct from the main band. The pump lightwave having the wavelength λₚᵤₘₚ and the probe lightwave that has the wavelength λ_{probe} and that is included in the subband are introduced into the optical fiber. In the optical fiber, the nonlinear optical phenomenon is generated and the idler lightwave having the wavelength λ_{idler} that is in accordance with the wavelength λ_{probe} is newly produced.

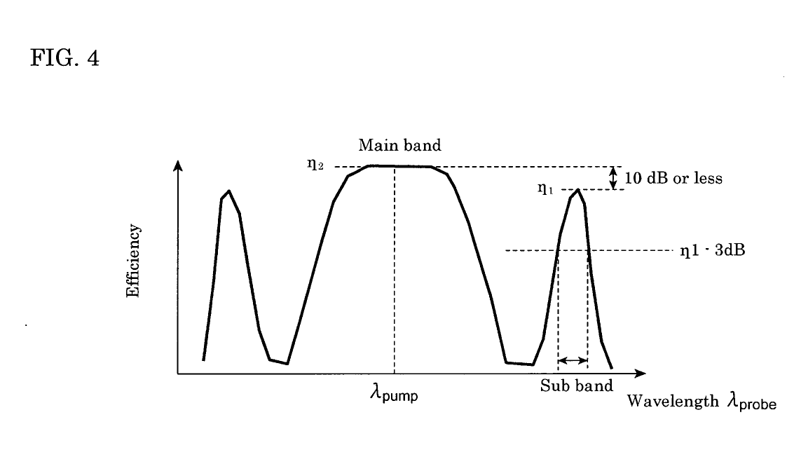

FIG. 4 is a graph showing a relationship between the wavelength λ_{probe} of the probe lightwave and the efficiency of the wavelength conversion in an embodiment of an optical device and wavelength conversion method of the present invention. In this embodiment, the efficiency of the wavelength conversion has the main band including the wavelength λₚᵤₘₚ of the pump lightwave and the subband distinct from the main band. The subband lies both at the longer-wavelength side and at the shorter-wavelength side of the main band. The subband has a narrower bandwidth than that of the main band.

The probe lightwave may have either one wavelength or a plurality of wavelengths. Each of the probe lightwave and the pump lightwave may either be a CW lightwave or be a pulse lightwave. The pump lightwave may be modulated. The probe lightwave may be a signal lightwave such as that is used in optical communication.

In comparison with the case where a wavelength of a probe lightwave in the main band is converted, an optical device and wavelength conversion method of this embodiment can perform a selective wavelength conversion of a probe lightwave having a specific wavelength included in a narrow bandwidth. In addition, the tuning of the wavelength of the pump lightwave can shift a wavelength of probe lightwave while maintaining high efficiency of wavelength conversion.

It is desirable that the subband have a bandwidth of at most 30 nm and that the difference between the maximum value, η₁, of the efficiency of the wavelength conversion in the subband and the maximum value, η₂, of the efficiency of the wavelength conversion in the main band be less than 10 dB. When this condition is satisfied, not only can the wavelength conversion be performed with high efficiency for the probe lightwave but also the influence of the four-wave mixing among prove lightwaves can be suppressed.

To perform wavelength-selective wavelength conversion, it is desirable that the subband have the narrowest possible bandwidth. The bandwidth of 30 nm corresponds to the gain bandwidth of a commonly used erbium-doped fiber amplifier (EDFA). It is more desirable that the subband have a bandwidth of at most 15 nm, yet more desirably at most 10 nm.

In the wavelength conversion performed through a four-wave mixing, it is desirable that the difference between the maximum value, η₁, of the efficiency of the wavelength conversion at the subband and η₂ be as small as possible. The upper-limit value 10 dB of the difference between η₁ and η₂ means that the lower limit of the maximum value of the efficiency of the wavelength conversion at the subband is 10 percent the maximum value of the efficiency of the wavelength conversion at the main band. It is more desirable that the difference between η₁ and η₂ be at most 5 dB, yet more desirably at most 3 dB.

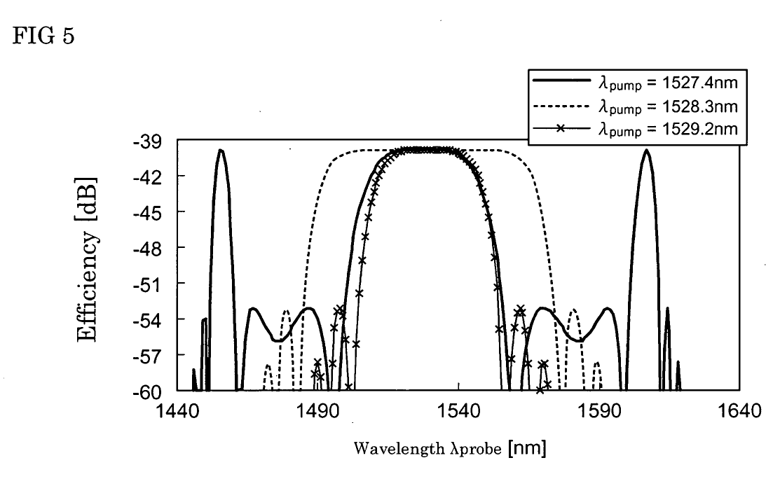

FIG. 5 is a graph showing the result of a simulation to obtain the relationship between the wavelength of the probe lightwave and the efficiency of the wavelength conversion in an optical fiber 101 that is negative in the value of the fourth-order differentiation, β₄, in the vicinity of the zero-dispersion wavelength. The optical fiber 101 has properties shown in Table I, in which the value of the fourth-order differentiation, β₄, is a value at the zero-dispersion wavelength, the polarization-mode dispersion (PMD) is a value at the C-band, and the other properties are values at 1550 nm. The nonlinear coefficient, _{Y}, is a value measured with the XPM method. (It is known that the CW-SPM method produces a value of about two-thirds.) The optical fiber 101 has a length of 200 m.

TABLE I

| | Optical fiber | Optical fiber | Optical fiber |
|---|---|---|---|
| Property | 101 | 102 | 103 |
| Zero-dispersion wavelength | 1528.3 | 1585.5 | 1480 |
| nm | | | |
| Dispersion ps/nm/km | +1.0 | −0.56 | +2.5 |
| Dispersion slope ps/nm²/km | +0.047 | +0.018 | +0.034 |
| Fourth-order differentiation β₄ | −1.7 × 10⁻⁵⁵ | 1.4 × 10⁻⁵⁵ | −7 × 10⁻⁵⁶ |
| s⁴/m | | | |
| Transmission loss dB/km | 1.3 | 0.7 | 0.5 |
| Effective area μm² | 12 | 9.7 | 12 |
| Nonlinear coefficient Υ/W/km | 18 | 25 | 19 |
| Mode-field diameter μm | 4.0 | 3.6 | 3.8 |
| PMD ps/km^{0.5} | 0.06 | 0.15 | 0.05 |

The optical fiber 101 receives a pump lightwave a power of +6 dBm and a probe lightwave having a power of −4 dBm.

The optical fiber 101 is negative in the value of the fourth-order differentiation, β₄, in the vicinity of the zero-dispersion wavelength. Consequently, when the optical fiber 101 receives a pump lightwave having a wavelength shorter than the zero-dispersion wavelength so that the value of the second-order differentiation, β₂, can become positive, the four-wave mixing-based wavelength conversion can be performed wavelength-selectively. On the contrary, when the optical fiber 101 receives a pump lightwave having a wavelength longer than the zero-dispersion wavelength, wavelength-selective wavelength conversion is not performed. More specifically, as shown by a solid line in FIG. 5, only when the pump lightwave has a wavelength of 1527.4 nm, which is shorter than the zero-dispersion wavelength, the wavelength conversion can be performed at subbands individually having center wavelengths of 1455 nm and 1607 nm. The wavelength conversion is performed with a relatively narrow bandwidth of 6 nm as shown in FIG. 5. In this case, when the probe lightwave has a wavelength of 1455 nm, the idler lightwave has a wavelength of 1607 nm. When the probe lightwave has a wavelength of 1607 nm, the idler lightwave has a wavelength of 1455 nm.

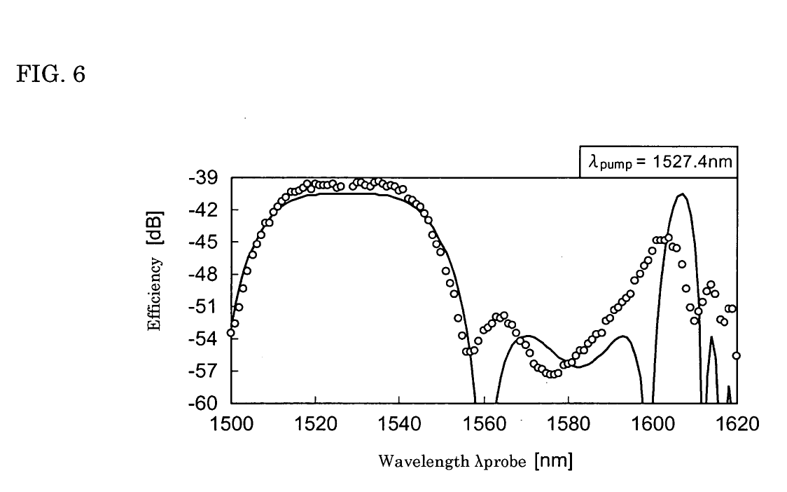

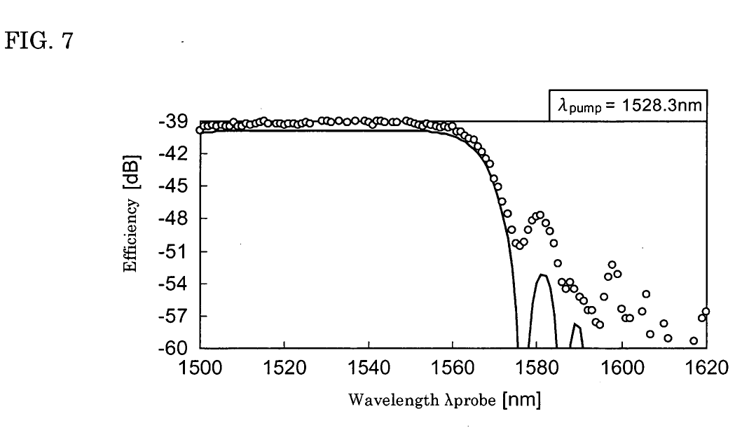

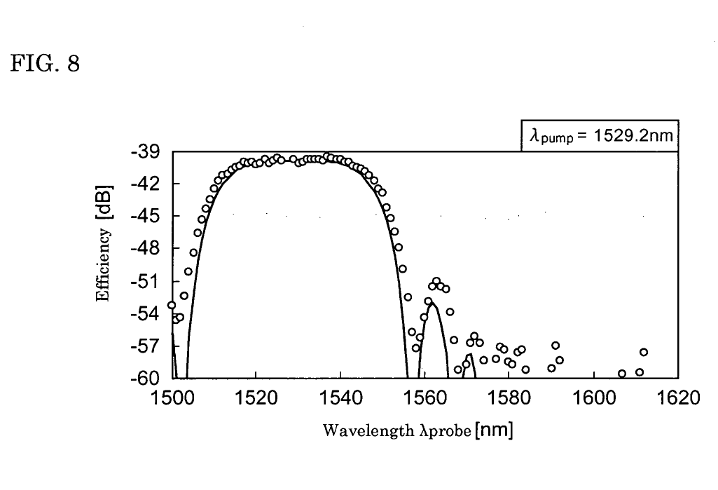

FIGS. 6, 7, and 8 are graphs showing the results of experiments to obtain the relationship between the wavelength of the probe lightwave and the efficiency of the wavelength conversion when the wavelengths λₚᵤₘₚ'S of the pump lightwave are 1527.4 nm, 1528.3 nm, and 1529.2 nm, respectively, in the fiber 101. In each of FIGS. 6 to 8, a solid line shows the simulation result and plotted white circles show the experimental result. In all the graphs, the simulation result and the experimental result are in good agreement with each other. In the experiment, also, only when the wavelength λₚᵤₘₚ of the pump lightwave is shorter than the zero-dispersion wavelength (1528.3 nm), which case is shown in FIG. 6, the wavelength conversion was achieved with the following results: The peak efficiency is −44.6 dBm at a wavelength of 1603 nm of the probe lightwave, which is in a subband, and the subband has a bandwidth of 10 nm. As shown in FIG. 6, when the probe lightwave has a wavelength in the vicinity of the wavelength of the pump lightwave, the efficiency of the wavelength conversion is −39.5 dBm. Therefore, the difference in the efficiency is −5.1 dBm.

The deviation between the simulation result and the experimental result is attributable to the factors such as the variation in the zero-dispersion wavelength along the length of the optical fiber, the polarization-mode dispersion, the dispersion term higher in the order than that of the value of the fourth-order differentiation, β₄. The efficiency of the wavelength conversion is proportional to the square of the power of the pump lightwave. This time, the power of the pump lightwave is as low as +6 dBm. Nevertheless, when the power of the pump lightwave is increased up to +22 dBm, which is the threshold value for the generation of the stimulated Brillouin scattering, the efficiency of the wavelength conversion will be increased to −13 dB.

So far such a wavelength conversion technique has not been studied. The technique can be utilized in an optical switch such as that wavelength-selectively drops a signal in a coarse wavelength division multiplexing (CWDM) system. The optical switch can become a wavelength selection switch having a very simple constitution.

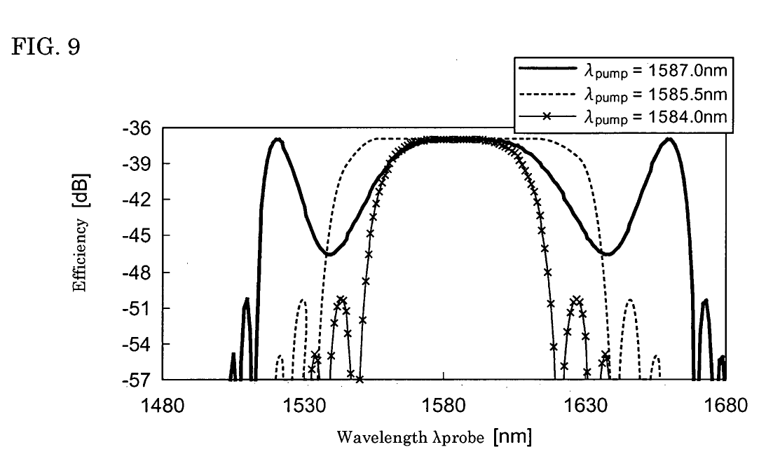

FIG. 9 is a graph showing the result of a simulation to obtain the relationship between the wavelength of the probe lightwave and the efficiency of the wavelength conversion in an optical fiber 102 that is positive in the value of the fourth-order differentiation, β₄, in the vicinity of the zero-dispersion wavelength. FIG. 9 shows individual cases in which the pump lightwave has a different wavelength, λₚᵤₘₚ, of 1587.0 nm, 1585.5 nm, or 1584.0 nm. The optical fiber 102 has properties shown in Table I and a length of 200 m.

The optical fiber 102 is positive in the value of the fourth-order differentiation, β₄, in the vicinity of the zero-dispersion wavelength. Only when the pump lightwave has a wavelength of 1587.0 nm, which is longer than the zero-dispersion wavelength, as shown in a solid line in FIG. 9, a subband with narrow wavelength bandwidths can be realized as follows: The wavelength conversion bandwidth is 10 nm at each of the center wavelengths of 1520 nm and 1660 nm. In this case, because the dispersion slope is small, a large value of the second-order differentiation, β₂, cannot be achieved unless the difference between the wavelength of the pump lightwave and the zero-dispersion wavelength is large. In addition, because the optical fiber 102 has a high _{Y} value, it has a higher efficiency than that of cases, in which the optical fiber 101 is used, shown in FIGS. 6 to 8.

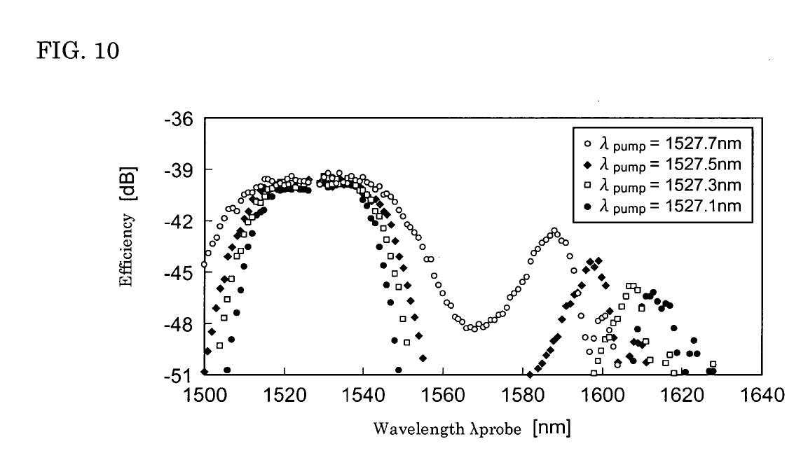

The tuning of the wavelength range of the subband enables the realization of a wavelength-tunable device. This can be achieved by changing the wavelength λₚᵤₘₚ of the pump lightwave. In an optical device and wavelength conversion method of the present invention, it is desirable that when the wavelength λₚᵤₘₚ of the pump lightwave is changed by 0.1 nm, the amount of shift in the center wavelength of the subband be at least one nm. The amount of shift in the center wavelength of the subband is 10 times that in the wavelength λₚᵤₘₚ of the pump lightwave in this case. By tuning the wavelength of the pump lightwave, the wavelength of the probe lightwave can be effectively shifted. This description is explained below by referring to FIG. 10 and Table II

FIG. 10 is a graph showing the result of an experiment to obtain the relationship between the wavelength of the probe lightwave and the efficiency of the wavelength conversion by using the wavelength of the pump lightwave as a parameter in the fiber 101. Table II shows the relationship between the wavelength λₚᵤₘₚ of the pump lightwave, the center wavelength of the subband, the bandwidth of the subband, and the maximum value, η₁, of the efficiency of the wavelength conversion in the subband.

TABLE II

| λₚᵤₘₚ nm | Center wavelength nm | Bandwidth nm | Efficiency dB |
|---|---|---|---|
| 1527.7 | 1588 | 14 | −42.6 |
| 1527.5 | 1588 | 12 | −44.3 |
| 1527.3 | 1608 | 9 | −45.8 |
| 1527.1 | 1613 | 9 | −46.2 |

The optical fiber receives a pump lightwave having a power of +6 dBm. As shown in FIG. 10 and Table II, the change of 0.2 nm in the wavelength λₚᵤₘₚ of the pump lightwave shifts the center wavelength of the subband by at least 2 nm. Thus, a wavelength-tunable optical device was realized. In addition, the efficiency of the wavelength conversion, η₂, of the probe lightwave having a wavelength in the vicinity of the wavelength of the pump lightwave is about −40 dB. Therefore, the difference with the maximum value, η₁, of the efficiency of the wavelength conversion in the subband is less than 10 dB. In particular, when the pump lightwave has a wavelength of 1527.7 nm, the difference is less than 3 dB.

Furthermore, when the zero-dispersion wavelength of the optical fiber is changed while the wavelength of the pump lightwave is being maintained constant, the value of the second-order differentiation, β₂, in the wavelength of the pump lightwave can be changed. In this case, it is not necessary to use a wavelength-tunable light source for the pump lightwave. The zero-dispersion wavelength of an optical fiber can be shifted by changing the temperature of the optical fiber (see T. Kato et al.) or by changing the amount of strain of it (see J. D. Marconi et al.).

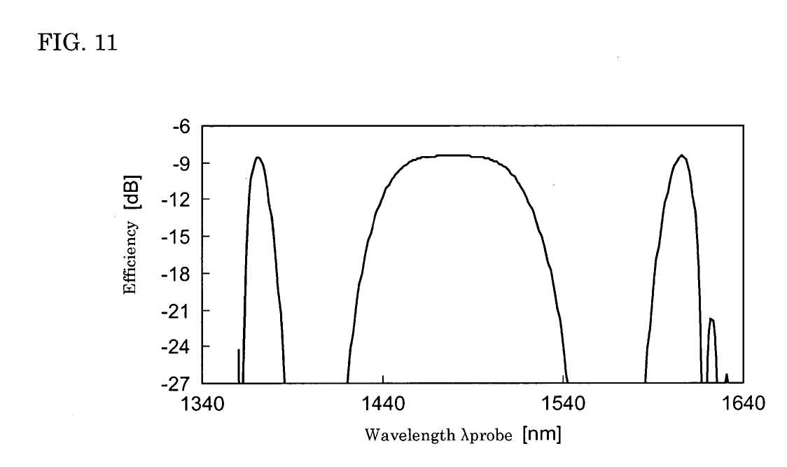

In an optical device and wavelength conversion method of the present invention, it is desirable that when the optical fiber receives a pump lightwave having an intensity of 1 mW (0 dBm), the efficiency of the wavelength conversion at the subband have a maximum value of at least −80 dB. When this condition is satisfied, when the optical fiber receives a pump lightwave having an intensity of 1 W (+30 dBm), which can be relatively easily achieved, the efficiency of the wavelength conversion at the subband has a maximum value of at least −20 dB. This feature is desirable in practical use. This description is explained below by referring to FIG. 11.

FIG. 11 is a graph showing the result of a simulation to obtain the relationship between the wavelength of the probe lightwave and the efficiency of the wavelength conversion in another optical fiber 103. The optical fiber 103 has properties shown in Table I and a length of 50 m. The optical fiber 103 receives a pump lightwave having a wavelength of 1478.8 nm and a power of +30 dBm. As shown in FIG. 11, the wavelength conversion can be performed at center wavelengths of 1370 nm and 1606 nm in sub bands, which are wavelengths of the probe lightwave. The wavelength conversion is performed with a bandwidth of 12 nm and a peak efficiency of −8.5 dB in the sub bands. This result corresponds to an efficiency of −68.5 dB that is obtained when the optical fiber receives a pump lightwave of 1 mW.

In an optical device and wavelength conversion method of the present invention, it is desirable that the pump lightwave have a wavelength of λₚᵤₘₚ lying in a range of 1440 to 1640 nm. When this condition is met, as the pump light source for outputting the pump lightwave, a low-cost high-output laser light source used in the optical communication can be used.

In an optical device and wavelength conversion method of the present invention, it is desirable that the optical fiber have a total length of at most 500 m. As the fiber length is decreased, the amount of variation in the zero-dispersion wavelength along the length of the optical fiber is decreased and the bandwidth of the subband is narrowed. When the optical fiber has a total length of at most 500 m, it is easy to decrease the amount of variation in the zero-dispersion wavelength along the length of the optical fiber to at most ±0.3 nm.

In an optical device and wavelength conversion method of the present invention, it is desirable that the difference between the wavelength λₚᵤₘₚ of the pump lightwave and the center wavelength of the subband be at least 50 nm. The wavelength λₚᵤₘₚ of the pump lightwave is nearly equal to the zero-dispersion wavelength of the optical fiber. Consequently, when a probe lightwave having a plurality of wavelengths included in the subband is introduced into the optical fiber, in the case where the wavelength λₚᵤₘₚ is close to the wavelength of the probe light, a problem is caused by the generation of the four-wave mixing between the probe lightwaves having different wavelengths. On the other hand, when the difference between the wavelength λₚᵤₘₚ of the pump lightwave and the center wavelength of the subband is at least 50 nm, the absolute value of the chromatic dispersion of the optical fiber at the subband becomes at least 1 ps/nm/km or so. Consequently, the generation of the four-wave mixing between the probe lightwaves having different wavelengths can be suppressed.

On the other hand, to apply to an optical communication system, it is also desirable that the difference between the wavelength λₚᵤₘₚ of the pump lightwave and the center wavelength of the subband be at most 100 nm. When this condition is satisfied, for example, for the pump lightwave, a wavelength of λₚᵤₘₚ lying in the C-band (wavelength: 1520 to 1565 nm) is used to convert a wavelength in the L-band (wavelength: 1570 to 1620 nm) to a wavelength in the S-band (wavelength: 1510 to 1460 nm). Alternatively, a lightwave in the S-band can be wavelength-converted to a lightwave in the L-band.

In an optical device and wavelength conversion method of the present invention, it is desirable that the probe lightwave or idler lightwave emerging from the optical fiber have an intensity larger than that of the probe lightwave entering the optical fiber. When this condition is met, a broadband optical amplification can be performed with the optical parametric amplification. In addition, not only the optical amplification operation but also functions of an optical switch and a demultiplexer can be performed by introducing a control pulse lightwave as the pump lightwave into the optical fiber.

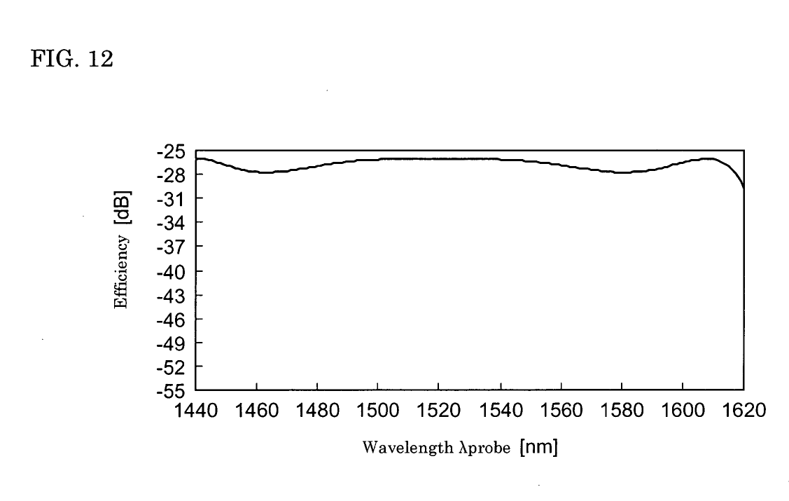

In an optical device and wavelength conversion method of the present invention, it is desirable that the value of the fourth-order differentiation, β₄, have an absolute value of at least 3×10⁻⁵⁶ s⁴/m, more desirably at least 1×10⁻⁵⁵ s⁴/m. It is desirable that the value of the fourth-order differentiation, β₄, have the largest possible absolute value for selectively performing the wavelength conversion of a probe lightwave having a specific wavelength. The absolute value in the value of the fourth-order differentiation, β₄, of the optical fiber and the dispersion slope of it can be controlled by optimizing the refractive-index profile of the optical fiber. This description is explained below by referring to FIGS. 12 to 14.

TABLE III

| | Optical fiber | Optical fiber | Optical fiber |
|---|---|---|---|
| Property | 104 | 105 | 106 |
| Zero-dispersion wavelength | 1520.0 | 1519.0 | 1519.5 |
| nm | | | |
| Dispersion ps/nm/km | +0.9 | +1.0 | +1.2 |
| Dispersion slope ps/nm²/km | +0.024 | +0.026 | +0.033 |
| Fourth-order differentiation β₄ | −1.6 × 10⁻⁵⁶ | −3.1 × 10⁻⁵⁶ | −9.6 × 10⁻⁵⁶ |
| s⁴/m | | | |
| Transmission loss dB/km | 1.2 | 1.2 | 1.2 |
| Effective area μm² | 8.6 | 8.6 | 8.6 |
| Nonlinear coefficient Υ/W/km | 30 | 30 | 30 |
| Mode-field diameter μm | 3.4 | 3.4 | 3.4 |
| PMD ps/km^{0.5} | 0.05 | 0.05 | 0.05 |

FIGS. 12, 13, and 14 are graphs showing the results of simulations to obtain the relationship between the wavelength of the probe lightwave and the efficiency of the wavelength conversion in optical fibers 104, 105, and 106, respectively, all having different absolute values in the value of the fourth-order differentiation, β₄, in the vicinity of the zero-dispersion wavelength. The optical fiber 104 used for FIG. 12 has properties shown in Table III, in which the value of the fourth-order differentiation, β₄, is a value at the zero-dispersion wavelength, the polarization-mode dispersion (PMD) is a value at the C-band, and the other properties are values at the wavelength of 1550 nm. The optical fiber 104 has a length of 300 m. The optical fiber 104 has a small value of the fourth-order differentiation, β₄. Consequently, the main band is continuous and very broad, covering the E- to U-bands. For example, when a pump lightwave having a wavelength of 1519.8 nm and a power of +10 dBm is introduced into the optical fiber, the dependence of the efficiency of the wavelength conversion on the wavelength of the probe lightwave is as shown in FIG. 12. The wavelength of the probe lightwave satisfying Eq. (6) is λ_{probe}=1610 nm. However, the efficiency of the wavelength conversion has no subband that is distinct from the main band.

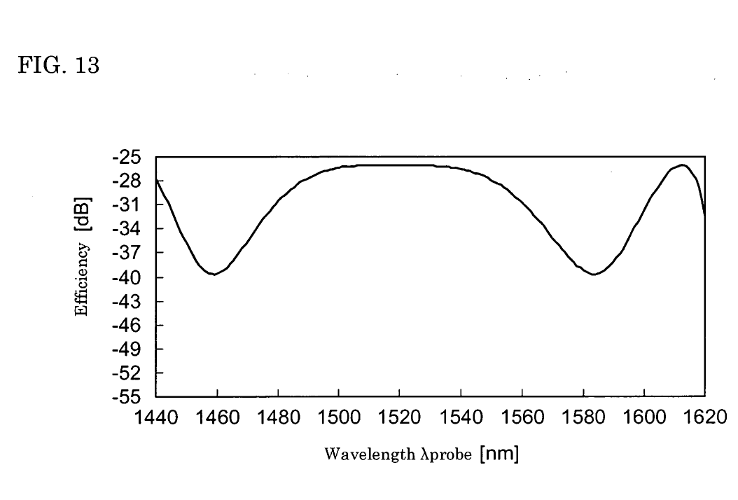

The optical fiber 105 used for FIG. 13 has properties shown in Table III and a length of 300 m. When the optical fiber 105 is used, because the value of the fourth-order differentiation, β₄, at the zero-dispersion wavelength is relatively large, the wavelength-selective wavelength conversion can be performed at the subband. For example, when a pump lightwave having a wavelength of 1519.8 nm and a power of +10 dBm is introduced into the optical fiber, the wavelength conversion spectra is as shown in FIG. 13; the wavelength conversion can be performed with a bandwidth of 15 nm at a center wavelength of 1612 nm.

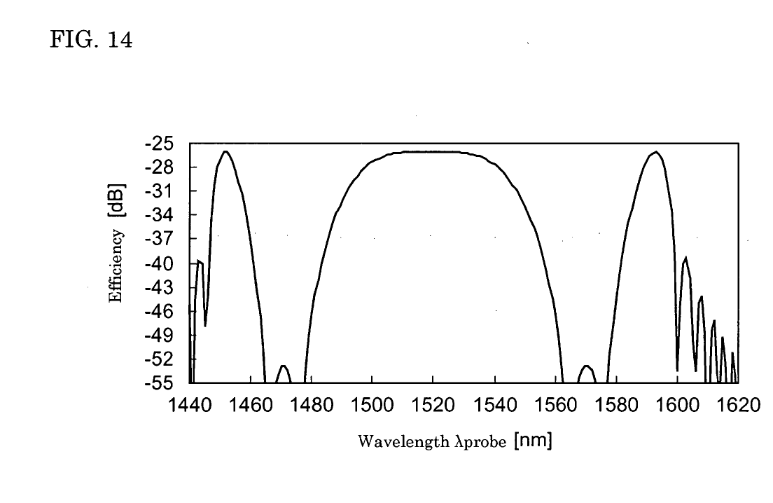

The optical fiber 106 used for FIG. 14 has properties shown in Table III and a length of 300 m. When the optical fiber 106 is used, because the value of the fourth-order differentiation, β₄, at the zero-dispersion wavelength is further increased than that of the optical fiber 105, the wavelength-selective wavelength conversion can be performed with a larger extinction ratio. For example, when a pump lightwave having a wavelength of 1518.9 nm and a power of +10 dBm is introduced into the optical fiber, the wavelength conversion spectra is as shown in FIG. 14; the wavelength conversion can be performed with a bandwidth of 8 nm at center wavelengths of 1453 nm and 1596 nm. As described above, it is more desirable that the absolute value in the value of the fourth-order differentiation, β₄, at the wavelength of the pump lightwave be at least 1×10⁻⁵⁵ s⁴/m.

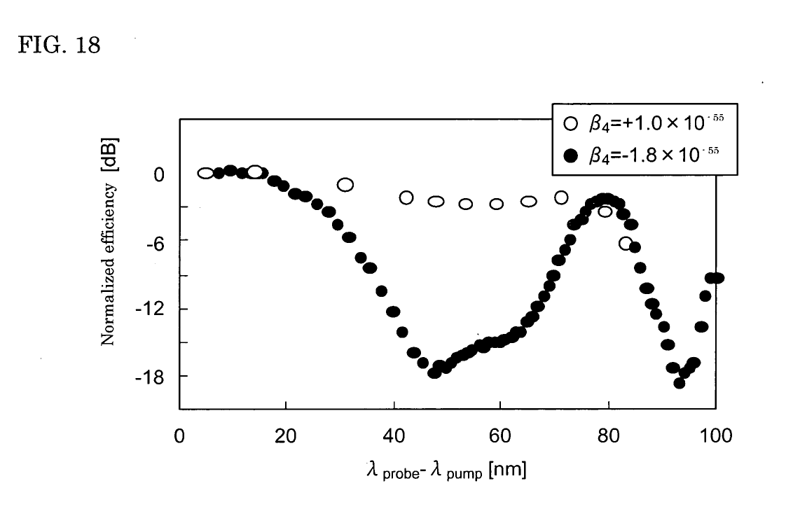

As the length of the optical fiber is decreased, the variation in the zero-dispersion wavelength is decreased. On the contrary, however, the bandwidth of the wavelength conversion band will be increased, because as shown in Eq. (12), the wavelength of the wavelength conversion band is inversely proportional to the length. In such a case, it is necessary to further increase |β₄|. FIG. 18 is a graph showing the result of an experiment to obtain the dependence of the normalized efficiency of the wavelength conversion on the amount of difference between the wavelengths of the pump lightwave and probe lightwave by using β₄ as a parameter. Optical fibers 107 and 108 used in the experiment have properties shown in Table IV, in which the values other than the zero-dispersion wavelength, the value of the fourth-order differentiation, and the polarization-mode dispersion (PMD) are values at 1550 nm. β₂/β₄ is designed to be −3×10²⁶ s² or so. Each of the optical fibers has a length of 100 m.

TABLE IV

| | Optical fiber | Optical fiber | Optical fiber |
|---|---|---|---|
| Property | 107 | 108 | 109 |
| Zero-dispersion wavelength | 1558.0 | 1528.0 | 1529.1 |
| nm | | | |
| Dispersion ps/nm/km | −0.2 | +1.0 | +1.2 |
| Dispersion slope ps/nm²/km | +0.019 | +0.047 | +0.042 |
| Fourth-order differentiation β₄ | 1.0 × 10⁻⁵⁵ | −1.8 × 10⁻⁵⁵ | −1.5 × 10⁻⁵⁶ |
| s⁴/m | | | |
| Transmission loss dB/km | 0.8 | 1.3 | 0.35 |
| Effective area μm² | 9.6 | 12 | 15 |
| Nonlinear coefficient Υ/W/km | 24 | 18 | 10 |
| Mode-field diameter μm | 3.6 | 4.0 | 4.6 |
| PMD ps/km^{0.5} | 0.03 | 0.06 | 0.02 |

The optical fiber 107, as shown by white circles, has no subband distinct from the main band. On the other hand, the optical fiber 108, as shown by black circles, has a subband with a conversion bandwidth of 10 nm at a wavelength of the probe lightwave about 80 nm away from the wavelength of the pump lightwave. As described above, it is desirable that |β₄|have a large value.

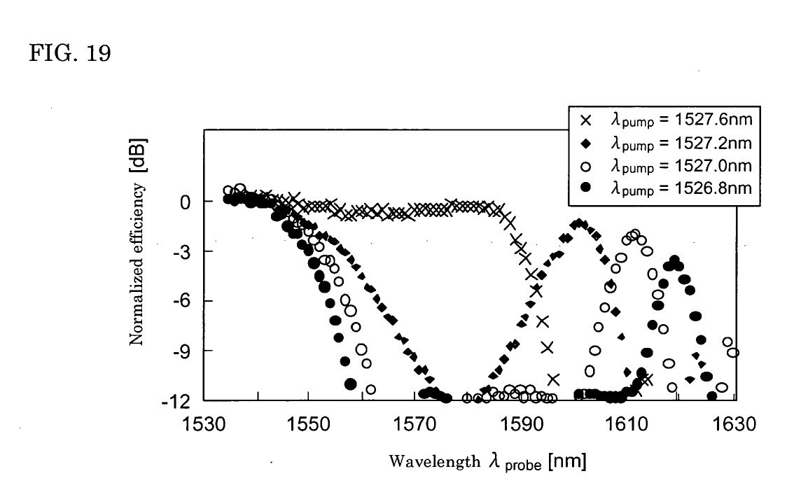

FIG. 19 is a graph showing the result of an experiment to obtain the dependence of the normalized efficiency of the wavelength conversion on the wavelength of the probe lightwave by using the wavelength of the pump lightwave as a parameter. Because the fiber length is as short as 100 m, the peak value of the efficiency of the wavelength conversion at the subband decreases no more than about 3 dB from the peak value of the efficiency of the wavelength conversion at the main band (the subband is located at the probe lightwave of 1620 nm). Furthermore, a tunable-type wavelength conversion is achieved in such a way that the shifting of the wavelength of the pump lightwave from 1527.2 nm to 1526.8 nm tunes the center wavelength of the subband from 1600 nm to 1620 nm with an extinction ratio of about 10 dB (the center wavelength of the subband is expressed by the wavelength λ_{probe} of the probe lightwave).

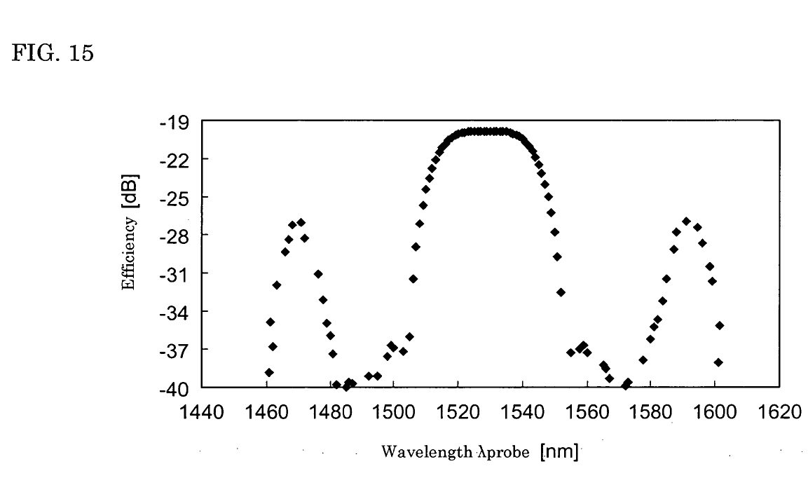

In an optical device and wavelength conversion method of the present invention, it is desirable that the amount of variation in the zero-dispersion wavelength along the length of the optical fiber be at most ±0.3 nm, more desirably at most ±0.1 nm. When the absolute value in the value of the second-order differentiation, β₂, at the wavelength λₚᵤₘₚ of the pump lightwave is varied, the center wavelength of the subband varies largely. Therefore, it is desirable that the amount of variation in the zero-dispersion wavelength along the length of the optical fiber be as small as possible. This description is explained below by referring to FIG. 15.

FIG. 15 is a graph showing the result of an experiment to obtain the dependence of the efficiency of the wavelength conversion on the wavelength of the probe lightwave in an optical fiber 109. The optical fiber 109 has properties shown in Table IV. The variation in the zero-dispersion wavelength along the length of the optical fiber 109 is ±0.1 nm (which is measured by the method of Mollenauer et al.). The optical fiber 109 has a length of 500 m.

When a pump lightwave having a wavelength of 1528.5 nm and a power of +15 dBm is introduced into the optical fiber 109, a wavelength-selective wavelength conversion device can be realized with subbands having a width of 10 nm at center wavelengths of 1471 nm and 1592 nm. The efficiency of the wavelength conversion in the subband is −27 dB at the maximum. In comparison with the maximum value of −20 dB in the efficiency of the wavelength conversion in the vicinity of the wavelength of the pump lightwave, the difference is within 10 dB.

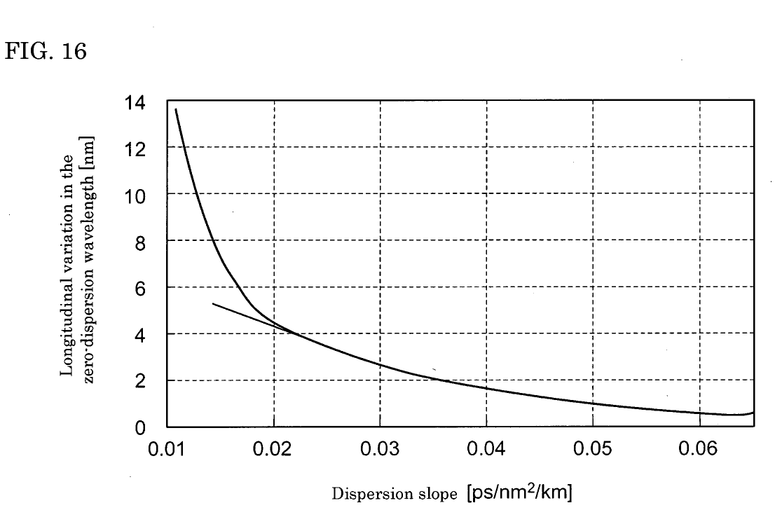

In an optical device and wavelength conversion method of the present invention, it is desirable that the optical fiber have a dispersion slope of at least +0.02 ps/nm²/km at the zero-dispersion wavelength, more desirably at least +0.04 ps/nm²/km. When this condition is satisfied, the variation in the zero-dispersion wavelength along the length of the optical fiber can be suppressed. This description is explained below by referring to FIG. 16.

FIG. 16 is a graph showing the relationship between the amount of longitudinal variation in the zero-dispersion wavelength and the dispersion slope in an optical fiber. The optical fiber used to obtain the relationship has an effective area of 8 to 12 μm² and a nonlinear coefficient, _{Y}, of 17 to 35 /W/km when measured by the XPM method. FIG. 16 shows that when the diameter of the core portion of the optical fiber varies 1% (±0.05%) along its length, to what extent the zero-dispersion wavelength varies. When the dispersion slope is less than +0.02 ps/nm²/km, the amount of variation in the zero-dispersion wavelength increases abruptly. Therefore, it is desirable that the optical fiber have a dispersion slope of at least +0.02 ps/nm²/km at the zero-dispersion wavelength. It is more desirable that the optical fiber have a dispersion slope of at least +0.04 ps/nm²/km. Generally, the achievable maximum value of the dispersion slope of a highly nonlinear optical fiber is about +0.06 ps/nm²/km.

In an optical device and wavelength conversion method of the present invention, it is desirable that the optical fiber have a polarization mode dispersion (PMD) of at most 0.2 ps in the total length. When this condition is achieved, the influence of the PMD is decreased, so that the nonlinear optical phenomenon in the optical fiber can be generated stably over a long period. In addition, it is desirable that the crosstalk between the orthogonally polarized waves of a fundamental mode lightwave guided in the optical fiber be at most −15 dB in the total length. The use of such a polarization-maintaining optical fiber decreases the influence of the coupling of two polarization modes to such an extent that it can be neglected. As a result, the nonlinear optical phenomenon in the optical fiber can be generated stably over a long period.

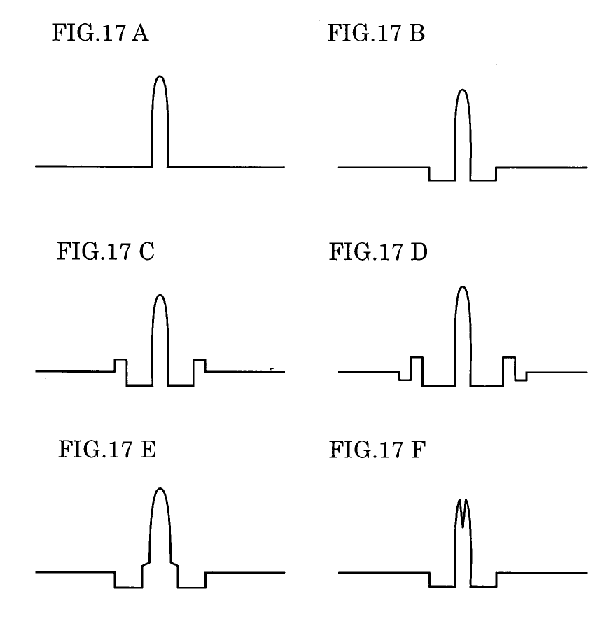

FIGS. 17A to 17F are schematic diagrams showing desirable examples of refractive-index profiles in embodiments of an optical fiber of the present invention. As the PMD is decreased, the band is broadened. Therefore, it is desirable that the PMD be at most 0.2 ps in the total length of the fiber used, more desirably at most 0.1 ps. It is yet more desirable to employ a commonly used PANDA-type structure, because this structure can suppress the coupling between the orthogonally polarized lightwaves in a guided mode (a fundamental mode of the optical fiber). Even when the fiber has a length of 1 km, the coupling between the polarized waves can be decreased to at most −15 dB. For the fiber length in actual use, the coupling can be further decreased.

An optical fiber suitable for an optical device and wavelength conversion method of the present invention has the following features: (a) the effective area is at most 15 μm² at a wavelength of 1550 nm, (b) the zero-dispersion wavelength lies in a range of 1440 to 1640 nm, (c) the dispersion slope is at least 0.04 ps/nm²/km at the zero-dispersion wavelength, (d) the absolute value in the value of the fourth-order differentiation, β₄, of the propagation constant, β, by the angular frequency, ω, is at least 1×10⁻⁵⁵ s⁴/m at the zero-dispersion wavelength, and (e) the amount of longitudinal variation in the zero-dispersion wavelength is at most ±0.3 nm.

In addition, the optical fiber may be wound into a small coil having a minimum bending diameter of, for example, at most about 40 mm. In this case, when the diameter of the protective coating of the optical fiber is decreased to, for example, at most 150 μm, the diameter of the coil can be further decreased. Furthermore, when the diameter of the glass portion of the optical fiber is decreased to, for example, at most 100 μm, the winding strain at the time of the winding into a small coil is decreased. As a result, not only can the possibility of the breaking be decreased but also the deterioration of the PMD due to the bending-induced birefringence can be suppressed.

In addition, it is desirable that the optical fiber have the highest possible nonlinear coefficient. In particular, it is recommended that the nonlinear coefficient be at least 10 /W/km. To realize this condition, it is desirable that the effective area be at most 15 μm². Furthermore, it is recommended that the center core portion not only have a high refractive index but also have a high nonlinear refractive index, N2. For example, it is recommendable to use silica glass doped with GeO₂ as the center core portion so that the relative refractive-index difference to pure silica glass can be at least 2.0 percent and the nonlinear refractive index, N2, can be at least 4×10⁻²⁰ m²/W when measured by the XPM method. It is also recommended that the mode-field diameter be small; for example, as small as at most 4.5 m.

It is recommended that the optical fiber have a low transmission loss. When this condition is met, the effective length of the optical fiber is increased, thereby increasing the efficiency of the conversion. It is recommended that the transmission loss be, for example, at most 10 dB/km, desirably at most 2 dB/km. To achieve this condition, it is desirable that the optical fiber be based on silica glass. It is desirable that the zero-dispersion wavelength and the wavelength of the pump lightwave be away from each other by 0.1 to 10 nm or so. Therefore, the optical fiber is required to be a dispersion-shifted optical fiber. From the viewpoint of the controllability of the chromatic dispersion, also, it is desirable to use a silica glass-based optical fiber.

The present invention is described above in connection with what is presently considered to be the most practical and preferred embodiments. However, the present invention is not limited to the disclosed embodiments, but, on the contrary, is intended to cover various modifications and equivalent arrangements included within the spirit and scope of the appended claims.

The entire disclosure of Japanese patent application 2006-127684 filed on May 1, 2006 including the specification, claims, drawing, and summary is incorporated herein by reference in its entirety.

What is claimed is:

1. An optical device, comprising:
(a) a pump light source for outputting a pump lightwave having a wavelength of λₚᵤₘₚ;
(b) a multiplexer for combining the pump lightwave and a probe lightwave having a wavelength of λ_{probe}; and
(c) an optical fiber that: (c1) guides the pump lightwave and the probe lightwave; and (c2) generates through a nonlinear optical phenomenon an idler lightwave having a newly produced wavelength of λ_{idler} that is in accordance with the wavelength λ_{probe}; in which device the wavelength λ_{probe} dependence of the efficiency of the wavelength conversion from the probe lightwave to the idler lightwave has a main band including the wavelength λₚᵤₘₚ and a subband distinct from the main band.

2. An optical device as defined by claim 1, wherein:
(a) the probe lightwave is at least one probe lightwave included in the subband; and
(b) the multiplexer combines the pump lightwave and the at least one probe lightwave.

3. An optical device as defined by claim 1, wherein:
(a) the subband has a bandwidth of at most 30 nm; and
(b) the difference between the maximum value, η₁, of the efficiency of the wavelength conversion at the subband and the maximum value, η₂, of the efficiency of the wavelength conversion at the main band is at most 10 dB.

4. An optical device as defined by claim 1, wherein when the amount of shift in the wavelength λₚᵤₘₚ of the pump lightwave is 0.1 nm, the corresponding amount of shift in the center wavelength of the subband is at least 1 nm.

5. An optical device as defined by claim 1, wherein
when the amount of shift in the zero-dispersion wavelength of the optical fiber is 0.1 nm, the corresponding amount of shift in the center wavelength of the subband is at least 1 nm.

6. An optical device as defined by claim 1, wherein
when a pump lightwave having an intensity of 1 mW is input into the optical fiber, the efficiency of the wavelength conversion at the subband has a maximum value of at least −80 dB.

7. An optical device as defined by claim 1, wherein
the pump lightwave has a wavelength of λₚᵤₘₚ lying in a range of 1440 to 1640 nm.

8. An optical device as defined by claim 1, wherein
the optical fiber has a total length of at most 500 m.

9. An optical device as defined by claim 1, wherein
the difference between the wavelength λₚᵤₘₚ of the pump lightwave and the center wavelength of the subband is at least 50 nm.

10. An optical device as defined by claim 1, wherein
the difference between the wavelength λₚᵤₘₚ of the pump lightwave and the center wavelength of the subband is at most 100 nm.

11. An optical device as defined by claim 1, wherein
one of the probe lightwave and the idler lightwave both output from the optical fiber has an intensity larger than that of the probe lightwave entering the optical fiber.

12. An optical device as defined by claim 1, wherein
the value of the fourth-order differentiation, β₄, of the propagation constant, β, by the angular frequency, ω, at the wavelength λₚᵤₘₚ of the optical fiber has an absolute value of at least 3×10⁻⁵⁶ s⁴/m.

13. An optical device as defined by claim 1, wherein
the amount of variation in the zero-dispersion wavelength over the total length of the optical fiber is at most ±0.3 nm.

14. An optical device as defined by claim 1, wherein
the optical fiber has a dispersion slope of at least +0.02 ps/nm²/km at the zero-dispersion wavelength.

15. A wavelength conversion method, comprising the steps of:
(a) guiding a pump lightwave having a wavelength of λₚᵤₘₚ and a probe lightwave having a wavelength of λ_{probe} in an optical fiber; and
(b) generating an idler lightwave having a newly produced wavelength of λ_{idler} that is in accordance with the wavelength λ_{probe} in the optical fiber through a nonlinear optical phenomenon; in which method:
(c) the wavelength λ_{probe} dependence of the efficiency of the wavelength conversion from the probe lightwave having the wavelength λ_{probe} to the idler lightwave having the wavelength λ_{idler} has a main band including the wavelength λₚᵤₘₚ and a subband distinct from the main band;
(d) at least one probe lightwave included in the subband is guided in the optical fiber; and
(e) at least one idler lightwave in accordance with the at least one probe lightwave is generated in the optical fiber.

16. An optical fiber, having:
(a) an effective area of at most 15 μm² at a wavelength of 1550 nm;
(b) a zero-dispersion wavelength lying in a range of 1440 to 1640 nm;
(c) a dispersion slope of at least 0.04 ps/nm²/km at the zero-dispersion wavelength;
(d) an absolute value in the value of the fourth-order differentiation, β₄, of the propagation constant, β, by the angular frequency, ω, being at least 1×10⁻⁵⁵ s⁴/m at the zero-dispersion wavelength; and
(e) an amount of longitudinal variation in the zero-dispersion wavelength being at most ±0.3 nm.
